(19) United States
(12) Patent Application Publication
(10) Pub. No.: US 2026/0266453 A1
(43) Pub. Date: Sep. 10, 2026

(54) Subsurface laser-engraved crystal ornament and illumination device therefor

(71) Applicant: Yuming Liu, Changsha (CN)

(72) Inventor: Yuming Liu, Changsha (CN)

(21) Appl. No.: 19/658,507

(22) Filed: Apr. 25, 2026

(30) Foreign Application Priority Data
Oct. 24, 2025 (CN) 202522252602.2
Oct. 24, 2025 (CN) 202522252813.6

(51) Int. Cl. F21V 23/06; F21S 9/02; F21W 121/00; F21Y 115/10

(52) U.S. Cl. CPC F21V 23/06; F21S 9/02; F21W 2121/00; F21Y 2115/10

(57) ABSTRACT

A subsurface laser-engraved crystal ornament and an illumination device therefor are provided. The subsurface laser-engraved crystal ornament includes a base, a crystal decorating part, an illumination device, and a light barrier. The lighttight light barrier is arranged on a rear side of the crystal decorating part, and can prevent divergence of light, so that subsurface laser-engraved patterns can be seen clearly in any case and have a better ornamental effect. A bottom plate and a mounting cover are connected and fixed through a screw. If an element such as a circuit board or a storage battery is damaged during use, the bottom plate can be removed for element replacement. During replacement, the subsurface laser-engraved crystal ornament will not be damaged, and service of the ornament will not be affected.

### TECHNICAL FIELD

The present disclosure relates to a subsurface laser-engraved crystal ornament and an illumination device therefor.

### BACKGROUND

A subsurface laser-engraved crystal ornament is a decorative ornament that is formed by engraving an interior of a crystal to form patterns or characters by using a subsurface laser engraving technology and has a three-dimensional (3D) suspension effect. The existing subsurface laser-engraved crystal ornament is composed of a non-transparent base and a transparent crystal decorating part that is fixed above the base and has subsurface laser-engraved patterns or characters. An illumination device is fixed on the base. Color mixing is performed on the subsurface laser-engraved patterns through light with different colors, so that the patterns present a colorful effect. At present, the illumination device on the market is generally mounted in a mounting slot at a top of the base. The crystal decorating part is fixed to the base in an adhered manner using glue. The crystal decorating part and the base are integrated and non-detachable once they are assembled. That is, the illumination device is disposed between the crystal decorating part and the base and cannot be detached. Consequently, if the illumination device malfunctions, it cannot be replaced, and the ornamental effect of the subsurface laser-engraved crystal ornament will be significantly compromised without illumination. In addition, a back surface of the existing crystal decorating part allows light to pass through from four sides, resulting in significant divergence of light. Under strong external lighting, the subsurface laser-engraved patterns cannot be seen clearly, leading to a poor ornamental effect.

### SUMMARY

In view of the drawbacks of the existing subsurface laser-engraved crystal ornament, a technical problem to be solved in the present disclosure is to provide a subsurface laser-engraved crystal ornament and an illumination device therefor. The illumination device can be replaced and has a better ornamental effect.

To achieve the above objectives, according to one aspect of the present disclosure, the present disclosure is implemented through the following technical measures: a subsurface laser-engraved crystal ornament includes a base, a crystal decorating part, and an illumination device. The base is non-transparent. The base is provided with a mounting opening. The crystal decorating part is fixed at a top of the base. The illumination device is disposed within the mounting opening.

Further, a lighttight light barrier is arranged on one side of the crystal decorating part.

The present disclosure further discloses an illumination device for a subsurface laser-engraved crystal ornament, including a mounting cover, a bottom plate, a circuit board, and a power supply. The circuit board and the power supply are disposed between the bottom plate and the mounting cover. The bottom plate is detachably connected to the mounting cover. A light-emitting diode (LED) lamp is arranged at a top of the circuit board, and a switch is arranged at a bottom. The circuit board is connected to the power supply through a wire. A switch hole is formed in the bottom plate.

Further, the power supply is a storage battery. A charging connector is arranged on the circuit board. A charging hole is provided on the mounting cover. A charging port is provided on the base.

Further, connection posts are arranged on both the mounting cover and the bottom plate. A fixing hole is provided on the circuit board. The mounting cover and the bottom plate are connected and fixed to each other through the connection posts.

Further, threaded holes are provided on the connection posts. The mounting cover and the bottom plate are connected and fixed to each other through a screw and the threaded holes of the connection posts.

Further, a light outlet hole is formed in a center of a top of the mounting cover.

Compared with the prior art, the present disclosure has the advantages below: The lighttight light barrier is arranged on the rear side of the crystal decorating part, and can prevent divergence of light, so that subsurface laser-engraved patterns can be seen clearly in any case. The bottom plate and the mounting cover are connected and fixed through the screw. If an element such as the circuit board or the storage battery is damaged during use, the bottom plate can be removed for element replacement. During replacement, the subsurface laser-engraved crystal ornament will not be damaged, and service of the ornament will not be affected.

### BRIEF DESCRIPTION OF THE DRAWINGS

The accompanying drawings that constitute a portion of the present disclosure are used to provide a further understanding of the present disclosure and form a part of the present disclosure. The illustrative embodiments and their explanations of the present disclosure are used to explain the present disclosure and do not constitute an improper limitation on the present disclosure. In the accompanying drawings:

FIG. 1 is a schematic diagram of an entire structure of a subsurface laser-engraved crystal ornament according to the present disclosure; and

FIG. 2 is a schematic diagram of an exploded structure of an illumination device for a subsurface laser-engraved crystal ornament according to the present disclosure.

Reference numerals in the accompanying drawings: 1: base; 2: crystal decorating part; 3: light barrier; 4: illumination device; 5: mounting opening; 6: charging port; 7: mounting cover; 8: bottom plate; 9: circuit board; 10: storage battery; 11: light outlet hole; 12: connection post; 13: threaded hole; 14: charging hole; 15: switch hole; 16: LED lamp; 17: fixing hole; 18: switch; and 19: charging connector.

### DETAILED DESCRIPTION OF THE EMBODIMENTS

The innovation of the present disclosure will be described in detail below with reference to the accompanying drawings and the embodiments. It should be noted that the embodiments in the present disclosure and features in the embodiments may be mutually combined without conflicts.

In the description of the innovation of the present disclosure, it should be understood that orientations or positional relationships indicated by the terms “center”, “upper”, “lower”, “left”, “right”, “vertical”, “horizontal”, “inside”, “outside”, “bottom”, “top”, and the like are orientations or positional relationships as shown in the drawings, and are only for the purpose of facilitating the innovation of the present disclosure and simplifying the description instead of indicating or implying that devices or elements indicated must have particular orientations, and be constructed and operated in the particular orientations, so that these terms are not construed as limiting the innovation of the present disclosure.

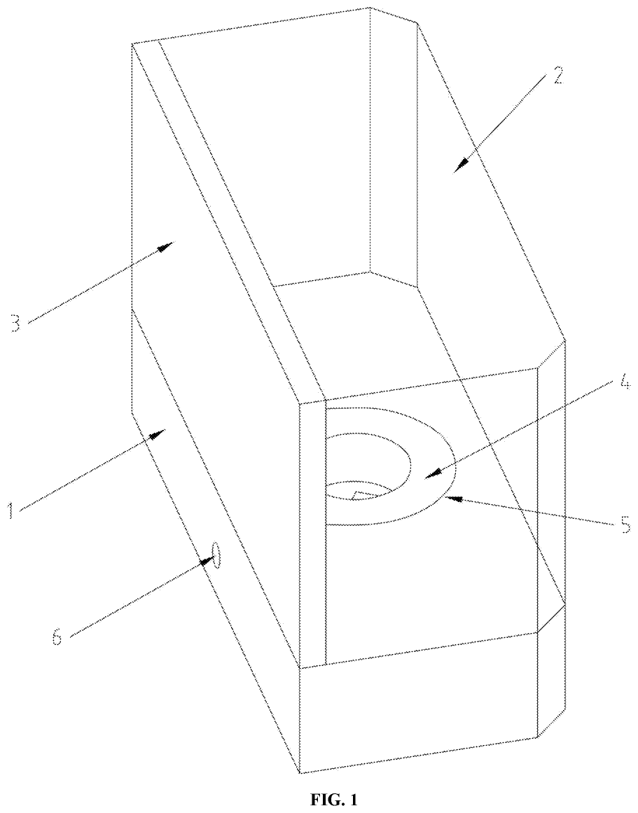

Referring to FIG. 1, this embodiment provides a subsurface laser-engraved crystal ornament, including a base 1, a crystal decorating part 2, a light barrier 3, and an illumination device 4. The base 1 is non-transparent. A mounting opening 5 penetrating through the base 1 is formed in a center of the base 1. A charging port 6 is formed in a side wall of the base 1. The crystal decorating part 2 is fixed at a top of the base 1. The lighttight light barrier 3 is arranged on a rear side of the crystal decorating part 2. The illumination device 4 is disposed within the mounting opening 5.

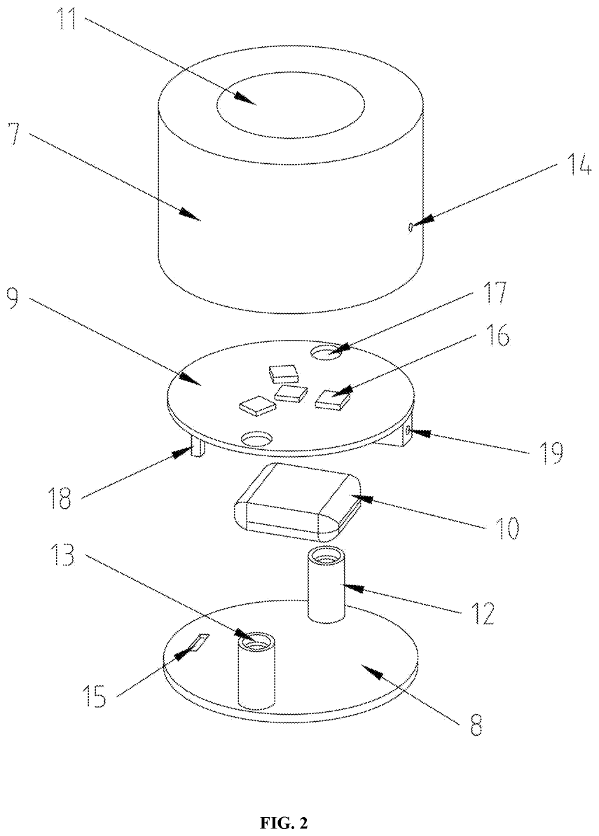

Referring to FIG. 2, this embodiment further provides an illumination device for a subsurface laser-engraved crystal ornament, including a mounting cover 7, a bottom plate 8, a circuit board 9, and a storage battery 10. The circuit board (9) and the storage battery 10 are disposed between the bottom plate 8 and the mounting cover 7. A light outlet hole 11 is formed in the middle of the mounting cover 7. Connection posts 12 are arranged on two sides of a bottom of the mounting cover 7. Threaded holes 13 are provided on the connection posts 12. A charging hole 14 is provided on a side wall of the mounting cover 7. Connection posts 12 are arranged on two sides of a top of the bottom plate 8. Threaded holes 13 are provided on the connection posts 12. A switch hole 15 is formed in the bottom plate 8. The mounting cover 7 and the bottom plate 8 are connected and fixed to each other through a screw and the threaded holes 13 on the connection posts 12. An LED lamp 16 is arranged at a top of the circuit board 9, and fixing holes 17 are provided on two sides. A switch 18 and a charging connector 19 are arranged at a bottom of the circuit board 9. The circuit board 9 is connected to the storage battery 10 through a wire. The storage battery 10 is a lithium-ion storage battery.

For the subsurface laser-engraved crystal ornament provided in this embodiment, during assembling, the illumination device 4 is first assembled. Then, the mounting cover 7 is disposed within the mounting opening 5 formed in the base 1. The mounting cover 7 can be fixedly connected to the base 1 in an adhered manner. Later, every two of the base 1, the crystal decorating part 2, and the light barrier 3 are fixedly connected to each other. Since the bottom plate 8 and the mounting cover 7 are connected and fixed to each other through the screw, if an element such as the circuit board 9 or the storage battery 10 is damaged during use, the bottom plate 8 can be removed for element replacement, instead of removing the crystal decorating part 2 and taking out the entire illumination device 4 from the interior of the base 1. During replacement, the subsurface laser-engraved crystal ornament will not be damaged, and service of the ornament will not be affected. The lighttight light barrier 3 is arranged on the rear side of the crystal decorating part 2, and can prevent divergence of light of the illumination device 4, so that subsurface laser-engraved patterns can be seen clearly in any case and have a better ornamental effect.

The above descriptions are only preferred embodiments of the present disclosure, and are not intended to limit the present disclosure. For those skilled in the art, the present disclosure may have various modifications and changes. Any modification, equivalent replacement, and improvement made within the spirit and scope of the present disclosure shall fall within the protection scope of the present disclosure.

What is claimed is:

1. A subsurface laser-engraved crystal ornament, comprising a base (1), a crystal decorating part (2), and an illumination device (4), wherein the base (1) is non-transparent; the base (1) is provided with a mounting opening (5); the crystal decorating part (2) is fixed at a top of the base (1); and the illumination device (4) is disposed within the mounting opening (5).

2. The subsurface laser-engraved crystal ornament according to claim 1, wherein a lighttight light barrier (3) is arranged on one side of the crystal decorating part (2).

3. An illumination device for a subsurface laser-engraved crystal ornament, applied to the subsurface laser-engraved crystal ornament according to claim 1, comprising a mounting cover (7), a bottom plate (8), a circuit board (9), and a power supply, wherein the circuit board (9) and the power supply are disposed between the bottom plate (8) and the mounting cover (7); the bottom plate (8) is detachably connected to the mounting cover (7); a light-emitting diode (LED) lamp (16) is arranged at a top of the circuit board (9), and a switch (18) is arranged at a bottom; the circuit board (9) is connected to the power supply through a wire; and a switch hole (15) is formed in the bottom plate (8).

4. The illumination device for the subsurface laser-engraved crystal ornament according to claim 3, wherein the power supply is a storage battery (10); a charging connector (19) is arranged on the circuit board (9); a charging hole (14) is provided on the mounting cover (7); and a charging port (6) is provided on the base (1).

5. The illumination device for the subsurface laser-engraved crystal ornament according to claim 3, wherein connection posts (12) are arranged on both the mounting cover (7) and the bottom plate (8); a fixing hole (17) is provided on the circuit board (9); and the mounting cover (7) and the bottom plate (8) are connected and fixed to each other through the connection posts (12).

6. The illumination device for the subsurface laser-engraved crystal ornament according to claim 5, wherein threaded holes (13) are provided on the connection posts (12); and the mounting cover (7) and the bottom plate (8) are connected and fixed to each other through a screw and the threaded holes (13) of the connection posts (12).

7. The illumination device for the subsurface laser-engraved crystal ornament according to claim 3, wherein a light outlet hole (11) is formed in a center of a top of the mounting cover (7).
